(19) United States
(12) Patent Application Publication
(10) Pub. No.: US 2014/0185439 A1
(43) Pub. Date: Jul. 3, 2014

(54) WIRELESS TERMINAL, CONTROL SERVER, AND WIRELESS COMMUNICATION SYSTEM USING SAME

(71) Applicant: HITACHI, LTD., Tokyo (JP)

(72) Inventors: Yoshiki SAKURAI, Tokyo (JP); Shiro MAZAWA, Tokyo (JP); Hiroaki KASAHARA, Tokyo (JP); Masao HAYAMA, Tokyo (JP)

(73) Assignee: HITACHI, LTD., Tokyo (JP)

(21) Appl. No.: 14/109,348

(22) Filed: Dec. 17, 2013

(30) Foreign Application Priority Data
Dec. 27, 2012 (JP) 2012-283908

(51) Int. Cl. H04W 28/02

(52) U.S. Cl. CPC H04W 28/0289
USPC 370/230

(57) ABSTRACT

In the case where a plurality of wireless systems differing in service area from each other are present, there is provided a wireless terminal having a function for collecting a history of application information, and a history of position information, a function for transmitting these histories to a priority table control server, a function whereby the priority table control server prepares a priority table on the basis of information obtained, and a function whereby the information is transmitted to the wireless terminal. The wireless terminal selects a connection destination on the basis of the information.

### CLAIM OF PRIORITY

The present application claims priority from Japanese patent application JP2012-283908 filed on Dec. 27, 2012, the content of which is hereby incorporated by reference into this application.

### BACKGROUND

The present invention relates to a wireless communication technology, and in particular, to a technology for selecting a wireless communication method in a communication area where a plurality of communication methods differing from each other can be used.

A wireless network is made up of various wireless communication methods such as LTE (Long Term Evolution), 3G {EV-DO (Evolution Data Only) etc.}, Wi-Fi (Wireless Fidelity), WiMax (Worldwide Interoperability for Microwave access) etc. The wireless communication methods have features differing from each other because of a difference in design concept, and so forth. For example, 3G has a feature of a wide communication range although low in throughput, and therefore, communications are continually possible even if a terminal shifts, whereas Wi-Fi has a feature of a narrow communication range although high in throughput, so that there is a possibility that Wi-Fi is forced to re-connect to other wireless communication methods if a terminal shifts. Because both a smart phone, and a tablet terminal, in particular, have lately come into widespread use, a traffic amount, in the case of wireless communications, has rapidly increased, so that a communication common carrier makes use of a plurality of wireless communication methods, dividing traffic among the various wireless communication methods described as above for use to thereby cope with a situation. More specifically, in Japanese Unexamined Patent Application Publication No. 2009-246874, there has been proposed selection of a wireless communication method regarded appropriate at a point in time, in consideration of the feature of a wireless communication method, radio field intensity, a throughput, a congestion degree of a user, a position, a mobile speed, and so forth.

### SUMMARY

However, if a wireless communication method is selected according to only information available at a selection point in time, there is a possibility that a wireless communication method that is selected at first will not turn out optimal if circumstances undergo a change after the selection. For example, suppose the case where a wireless terminal that is present in respective cover areas of Wi-Fi and 3G is not shifting, and the wireless terminal starts video reproduction. If there exist policies including a policy of selecting a wireless communication method high in throughput, and a policy of selecting a wireless communication method having a wide cover area when the wireless terminal is shifting in the case where the wireless terminal is shifting, and a user makes use of an application high in network load such as one at the time of the video reproduction, the wireless terminal selects Wi-Fi high in circuit speed under circumstances where Wi-Fi is not congested. However, if the wireless terminal starts shifting to be off the cover area of Wi-Fi, there is the need for reconnecting to 3G having a wide cover area. Thus, if reconnection to another wireless communication method is made, this will cause the start of service to be delayed, and a load of wireless signaling will increase, resulting in deterioration of user's QoE (Quality of Experience). Accordingly, it is an object of the present invention to select a suitable wireless communication method at the time of selecting one wireless communication method in the wireless network made up of a plurality of wireless communication methods to thereby enhance the user's QoE (Quality of Experience) by causing wasteful switching of a network to be reduced.

A wireless communication system according to an aspect of the invention includes a wireless terminal compatible with a plurality of wireless communication methods; a plurality of base stations that communicate with the wireless terminal according to the plural wireless communication methods, respectively; and a control server that communicates with the plural base stations via a network, and stores priority information including a mobile history information on the wireless terminal. The control server for the priority information transmits the priority information to the wireless terminal, and the wireless terminal selects the wireless communication method for use in communications on the basis of the priority information received.

According to the aspect of the present invention, wireless communications with reduction in frequency of re-connection can be realized even in the case of shifting made by the wireless terminal.

### BRIEF DESCRIPTION OF THE DRAWINGS

FIG. 1 is a view showing a wireless communication system according to one embodiment of the invention;

FIG. 2 is a functional block diagram of a priority table control server according to the one embodiment of the invention;

FIG. 3 is a functional block diagram of a wireless terminal according to the one embodiment of the invention;

FIG. 4 is a view showing a sequence of the wireless communication system according to the one embodiment of the invention;

FIG. 5 is a flow chart relating to a method for selecting a wireless communication method of the wireless terminal according to the one embodiment of the invention;

FIG. 6 is a block diagram of a priority table according to the one embodiment of the invention;

FIG. 7 is a flow chart for updating of the priority table according to the one embodiment of the invention, at the time of a call-connection, and for a terminal information transmitting method;

FIG. 8 is a flow chart for transmission of terminal information, according to the one embodiment of the invention;

FIG. 9 is a flow chart for recording an application-activation time according to the one embodiment of the invention;

FIG. 10 is a table for accumulated information in a priority table control server according to the one embodiment of the invention;

FIG. 11 is a flow chart for determining priority information on the basis of mobile information and application usage information, according to the one embodiment of the invention;

FIG. 12 is a determination-result table for the priority information according to the one embodiment of the invention;

FIG. 13A is a flow chart for preparation of the priority table according to the one embodiment of the invention; and

FIG. 13B is the flow chart for preparation of the priority table according to the one embodiment of the invention.

### DETAILED DESCRIPTION

First, a wireless communication system according to an embodiment of the invention is a wireless communication system provided with a wireless terminal compatible with a plurality of wireless communication methods, a plurality of base stations for communicating with the wireless terminal, according to each of the plural wireless communication methods, and a control server for communicating with the plural base stations via a network, and storing priority information including a mobile history information on the wireless terminal, and a priority information control server transmits the priority information to the wireless terminal, and the wireless terminal selects a wireless communication method for use in communications on the basis of the priority information. For example, if there are provided a first base station ready for a first wireless communication method equivalent to EVDO, and a second base station ready for a second wireless communication method equivalent to Wi-Fi, the second base station being narrower in communication range than the first base station, a first throughput information received from the first base station is compared with a second throughput information received from the second base station to thereby select a wireless communication method to be used for communications. If such a configuration as described is adopted, an optimum wireless communication method can be selected on the basis of information such as the mobile history information, and so forth. Further, an application usage history information item such as a network load information item and so forth is preferably included in the priority information. In this connection, the control server preferably has a configuration whereby a mobile distance of the wireless terminal, within predetermined time, is worked out according to the mobile history information, and a wireless communication method for use in communication is selected on the basis of results of an evaluation determining that a movement has taken place if the mobile distance as worked out is greater than a predetermined threshold. Further, if a value resulting from division of the first throughput information piece by the second throughput information piece is greater than a pre-stored first threshold, and the first throughput is greater than a pre-stored second threshold even in the case of the evaluation determining that the movement has taken place, a configuration for selecting the first wireless communication method is preferable. On the other hand, if the value resulting from division of the first throughput information piece by the second throughput information piece is smaller than the pre-stored first threshold, and the second throughput is greater than the pre-stored second threshold even in the case of the evaluation determining that the movement has not taken place, a configuration for selecting the second wireless communication method is preferable.

A control server according to the embodiment of the invention is a control server for receiving priority information including a mobile history information item transmitted from a wireless terminal compatible with a plurality of wireless communication methods. The control server is preferably provided with a storage unit for storing the priority information, a priority table preparation unit for preparing a priority table on the basis of the priority information stored, and a communications unit for transmitting the priority table as prepared to the wireless terminal in response to a request from the wireless terminal. Further, the control server preferably has a configuration whereby a mobile distance of the wireless terminal in predetermined time is worked out according to the mobile history information as received, and if the mobile distance as worked out is greater than a predetermined threshold, a determination as presence of shifting is made, and the result of the determination is reflected in the priority table. Still further, the control server preferably has a configuration whereby the priority information includes an application usage history information item, and indicates a wireless communication method to be used in communications to the wireless terminal on the basis of the mobile history information and the application usage history information.

Further, a wireless terminal according to the embodiment of the invention is preferably a wireless terminal compatible with a plurality of wireless communication methods, and the wireless terminal is preferably provided with a memory for storing mobile history information on the wireless terminal, a communication unit for transmitting the mobile history information as stored on one hand, and receiving a priority table prepared by a control server on the basis of the mobile history information transmitted, and a controller for selecting one of the plural wireless communication methods on the basis of the priority table received. Thus, even in the case of shifting made by the wireless terminal, it is possible to realize wireless communications with reduction in frequency of re-connection by taking the information related to network load into consideration.

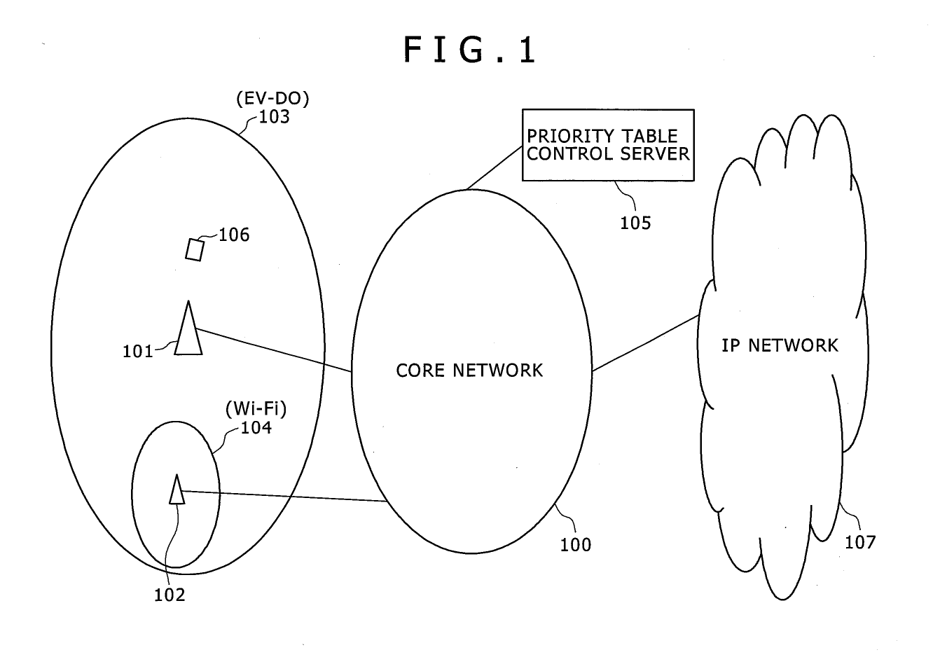

The embodiment of the invention is described hereinafter with reference to the accompanied drawings. The embodiment of the invention, however, is strictly one embodiment of the invention, and it is to be point out that the invention be not limited by this embodiment. First, FIG. 1 shows a service area (communications range) of a wireless system using different wireless communication methods such as EV-DO, and Wi-Fi. This system is a wireless system using an EV-DO wireless communication method, and a Wi-Fi wireless communication method. The EV-DO wireless communication method and the Wi-Fi wireless communication method have respective service areas differing in size from each other, the respective service areas having portions overlapping each other. EV-DO is made up of an EV-DO base station 101 for communicating with a wireless terminal, and a core network 100 for executing data communications with the EV-DO base station 101, call-processing, and authentication as well as accounting of the wireless terminal, the core network 100 being made up of switches as well as transmission lines, for use in connection among devices having respective functions described as above. Similarly, Wi-Fi is made up of a Wi-Fi base station 102, and the core network 100.

Further, a priority table control server 105 is connected to the core network 100 to prepare a priority table by use of an application usage information item as well as a position information item, transmitted from the wireless terminal, thereby delivering the priority table to the wireless terminal via the system of EV-DO or Wi-Fi.

When a wireless terminal 106 is present in either a wireless area 103 formed by the EV-DO base station 101 or a wireless area 104 formed by the Wi-Fi base station 102, or both thereof, the wireless terminal 106 is connected to an IP network 107 via the core network 100. When the wireless terminal 106 is connected thereto, the wireless terminal 106 starts connection according to the priority table acquired from the priority table control server 105. Further, the wireless terminal 106 transmits an activation start time as well as an activation completion time of the application, and the position information to the priority table control server 105. A connection method using the priority table, a method for transmitting the activation start time as well as the activation completion time of the application, and the position information are described in detail later.

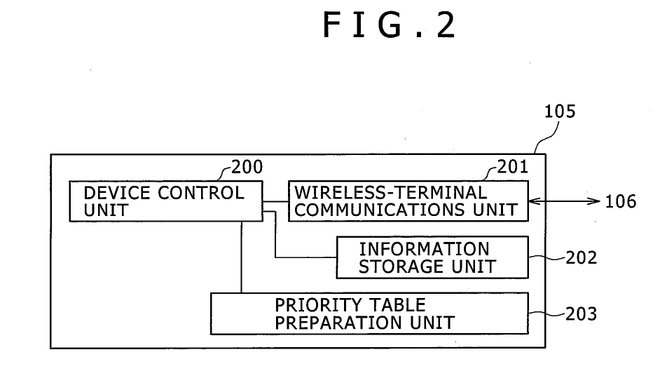

Next, a method for connection to a wireless communication method using the priority table is described. FIG. 2 shows one example of a functional block diagram of the priority table control server 105. The priority table control server 105 is provided with a device control unit 200 for controlling respective function units in a device, a wireless-terminal communications unit 201 for acquiring the application usage information as well as the position information from the wireless terminal 106 and delivering the priority table prepared in the device to the wireless terminal 106, an information-storage unit 202 for accumulating respective information items acquired from the wireless-terminal communications unit 201, and recording the priority table prepared by a priority table preparation unit 203, and the priority table preparation unit 203 for preparing the priority table by use of respective information items held in the information-storage unit 202.

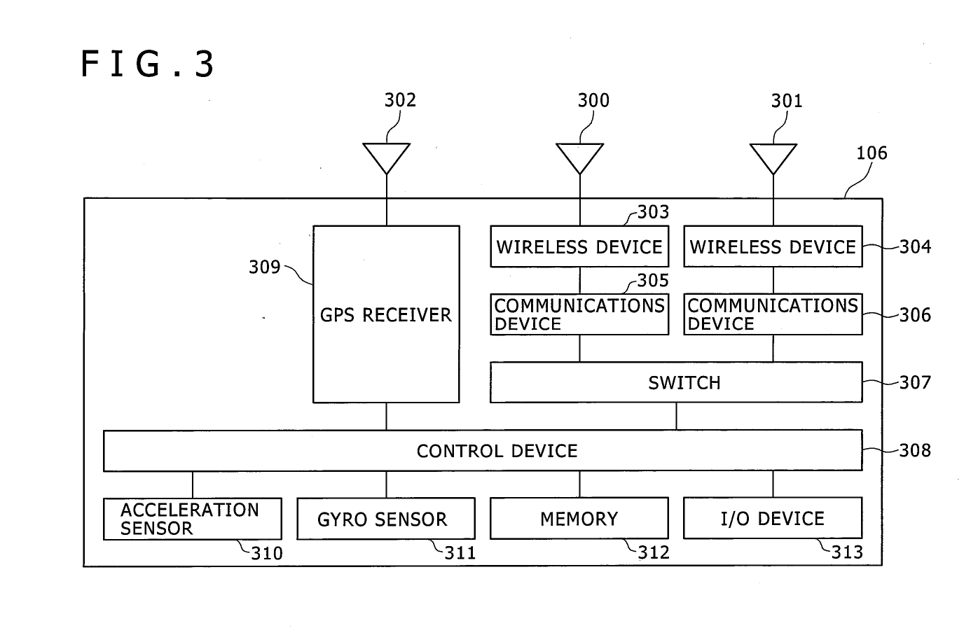

Now, FIG. 3 shows an example of a block diagram of the wireless terminal 106. The wireless terminal 106 is provided with communication devices compatible with the plural wireless communication methods, respectively, in order to select one wireless communication method from among the plural wireless communication methods, and two wireless devices in order to execute processing for switching to another wireless system during communications in a wireless system. The wireless terminal 106 has an antenna 300, and an antenna 301, together with a wireless device 303, and a wireless device 304, for executing communications with the base station, executing communications with two wireless systems at respective frequencies differing from each other. These wireless devices are connected to respective communication devices compatible therewith. The communication devices 305, 306 are devices compatible with respective wireless systems of wireless communication methods differing from each other, executing signal modulation/demodulation, coding, and decoding. These communication devices are each connected to a switch 307 for changing over connection when a wireless communication method is selected. A control device 308 is a processor for controlling inside the wireless terminal, and activating an application such as video reproduction, speaking, e-mail, and Internet to thereby execute processing. In order to keep track of the position of the wireless terminal, a GPS receiver 309 and an antenna 302 are incorporated in the wireless terminal. The control device 308 keeps track of the position information on the wireless terminal by the GPS receiver 309 periodically measuring the position of the wireless terminal. Further, the wireless terminal is provided with an acceleration sensor 310, and a gyro-sensor 311 to thereby keep track of an approximate shifting of the wireless terminal, and the control device 308 may identify or estimate the position information by combination with information acquired by the GPS receiver 309. A memory 312 holds information on an application used in the wireless terminal, the position information on the wireless terminal, and the priority table received from the priority table control server 105. A user of the wireless terminal gives an instruction to the wireless terminal by making use of an I/O device 313 such as a keyboard, an LCD panel, a speaker, and a microphone, and checks the result of the instruction.

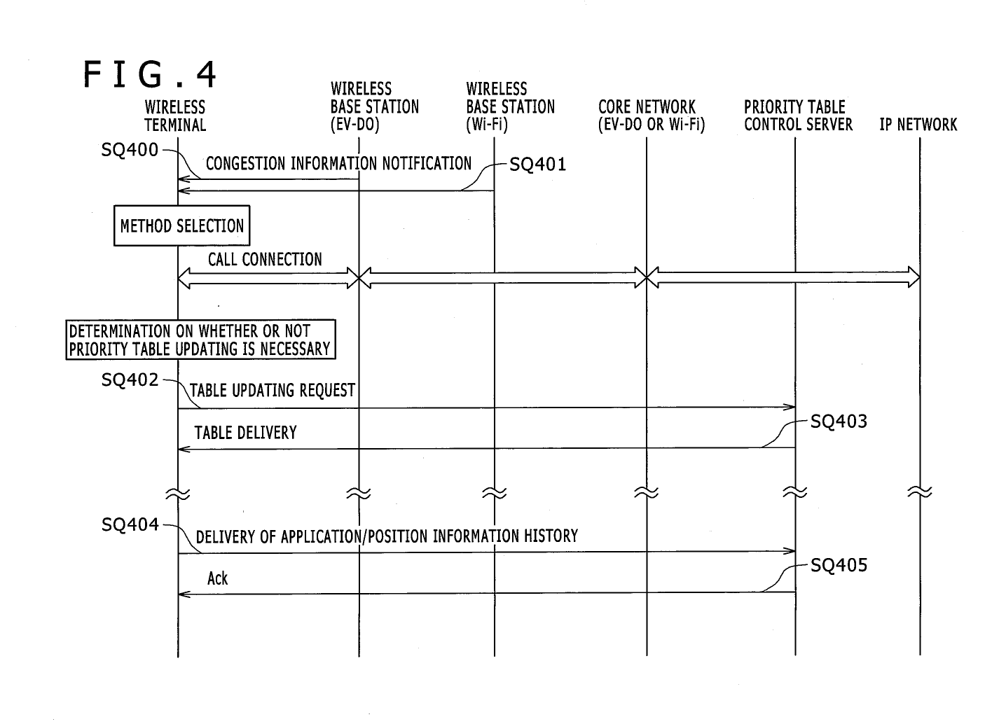

Next, call flows as a whole in this system are described hereinafter with reference to FIG. 4. First, the base stations each calculate a throughput per person from throughput, and the number of persons present in a wireless area, executing periodical broadcast delivery of information as acquired to the wireless terminals. Herein, by “a throughput” is meant the maximum data-traffic per unit time of a communication circuit. In this case, the throughput per person is defined as a formula expressed by the throughput/{(the number of persons)+1} (SQ400, SQ401). The wireless terminal selects a wireless communication method to be connected on the basis of the priority table as pre-delivered, and the throughput per person, for each of the base stations, as notified, at the time of activation of an application. Then, the wireless terminal executes a call-connection to the wireless communication method as selected, thereby starting communications. The wireless terminal determines whether or not priority table updating is necessary during the communications, and if the priority table updating is necessary, the wireless terminal executes a table-updating request against the priority table control server via a system in the course of the communications (SQ402). Upon receipt of this request, the priority table control server delivers the priority table prepared beforehand to the wireless terminal (SQ403).

Further, the wireless terminal is managed by one timer or a plurality of timers. The one timer is for use when the wireless terminal executes a call-connection in the case where the wireless terminal is not executing a call-connection during a given time-period to thereby deliver the application usage information and the position information of the wireless terminal to the priority table control server. Further, in the case where the wireless terminal is using an application, and a call-connection has been established, there may be an additional wireless terminal for use in delivery of the application usage information and the position information of the wireless terminal, necessary for the preparation of the priority table, to the priority table control server (SQ404). In this case, the priority table control server having received the priority table sends out Ack to the wireless terminal (SQ405). The wireless terminal executes a series of these call flows to thereby select a connection destination according to the priority table prepared by the priority table control server.

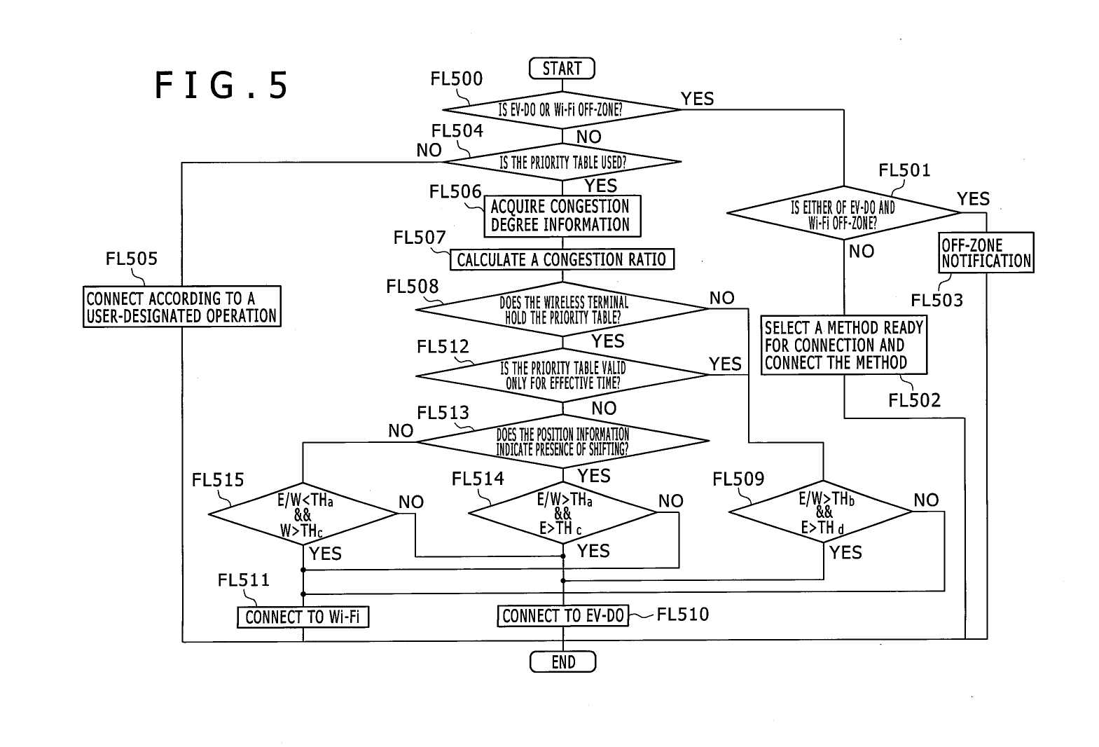

Next, a series of flows from the activation of an application, by the wireless terminal, up to the execution of a connection to a network, are described hereinafter with reference to FIG. 5. First, a determination is made on whether either the EV-DO wireless communication method or the Wi-Fi wireless communication method is off-zone or not, before the wireless terminal executes data communications (step FL500). If either one of the wireless communication methods is off-zone, a determination is made on whether or not the other thereof, as well, is off-zone (step FL501, and if the other thereof is not off-zone, the wireless communication method that is ready for connection is selected to be then connected (step FL502), while if the other thereof as well is outside the zone, off-zone notification is given to the wireless terminal (step FL503). If both the Wi-Fi wireless communication method and the EV-DO wireless communication method are inside a zone, a determination on whether or not the user is a user making use of the priority table is made. A determination on whether or not use is made of the priority table may be pre-determined at the time of the user entering into a contract, or during the setting of the wireless terminal (step FL504). If use is not made of the priority table, the connection is made according to a user-designated operation (step FL505). If use is made of the priority table, information items on the throughput per person, transmitted by broadcasting from the respective base stations of both the wireless communication methods, respectively, are acquired from the memory (step FL506), and a congestion ratio is calculated from the information on the throughput per person. The information on the throughput per person is the throughput/{(the number of persons)+1}, and the greater the number of persons is, the smaller this value becomes. In other words, this shows that the smaller this value is, the more the wireless communication method is congested.

Assuming that a throughput per person in Wi-Fi is defined as W, and a throughput per person in EV-DO is defined as E, E/W is found as a congestion ratio. It means that the greater this value becomes, Wi-Fi is more congested against EV-DO, while the smaller this value becomes, EV-DO is more congested against Wi-Fi (step FL507). A determination on whether or not the wireless terminal holds a priority table is made after calculation of the congestion ratio (step FL508). If the wireless terminal does not hold the priority table, a connection destination is determined according to a default operation (step FL509). Further, if the priority table is valid only for effective time although the wireless terminal holds the priority table (step FL512), the connection destination is similarly determined according to the default operation. This priority table includes mobile information, a congestion-ratio threshold, a throughput threshold and the effective time of the priority table, all of which are correspond to every passage of time, while the priority table that is valid only for the effective time does not include the mobile information, the congestion ratio threshold, and the throughput threshold. By “mobile information” is meant information expressing a possibility of user shifting, or a degree of shifting, and if the user shifts more than a predetermined reference, the mobile information is defined as “presence of shifting”, while if the user shifts less than the predetermined reference, the mobile information is defined as “lack of shifting”. In this connection, a user makes a decision on the mobile information according to a determination on whether or not the user tends to shift at a relevant time on the basis of position information items so far accumulated in the priority table control server. A method for preparing a priority table, a method for delivering a priority table, and the priority table are described in detail later on.

Further, in the default operation, use is made of a threshold TH_{b} against the congestion ratio E/W, as well as a threshold TH_{d} against the throughput of EV-DO, predetermined by an operator, to thereby determine selection of either EV-DO or Wi-Fi. Then, the values acquired, and calculated, in the steps 506, 507, respectively, are compared with these thresholds, respectively, and if E/W is greater than TH_{b}, and E is greater than TH_{d}, connection is made to EV-DO (step FL510), otherwise, connection being made to Wi-Fi (step FL511). A determination on a congestion-degree of a wireless communication method to be connected is made by use of a threshold against a throughput, and if a congestion degree of the wireless communication method to be connected is at the threshold or higher, connection is made to the wireless communication method. Even if the congestion degree of the wireless communication method that is connected is below the threshold, and the wireless communication method is congested, a determination on a connection destination, in consideration of the congestion states of other wireless communication methods, can be made by observing the respective congestion ratios of EV-DO, and Wi-Fi.

If the wireless terminal is found to hold the priority table, and information outside the effective time by the determinations made in the steps FL508, 512, respectively, a determination on whether a position information piece corresponding to a present time indicates “presence of shifting” or “lack of shifting” in the priority table held by the wireless terminal is made (step FL513). If the position information piece corresponding to a relevant time indicates “presence of shifting”, a threshold THₐ against the congestion ratio E/W in the priority table is compared with E/W calculated in the step FL509, and a threshold TH_{c} against the throughput of EV-DO in the priority table is compared with E acquired in the step FL506. Herein, the threshold THₐ is a threshold against the congestion ratio E/W, pre-prepared by the priority table control server. The threshold TH_{c} is a threshold against a throughput pre-prepared by the priority table control server, being treated as a threshold against the throughput of EV-DO because EV-DO has a feature in that EV-DO is wide in cover area (communications range), and low in throughput in the case of “presence of shifting”, while the threshold TH_{c} is a threshold against the throughput of Wi-Fi because Wi-Fi has a feature in that Wi-Fi is narrow in cover area (the communications range), and high in throughput in the case of “lack of shifting” (step FL514). With the use of this decision criteria, connection is made to EV-DO if E/W is greater than the threshold THₐ, and E is greater than the threshold TH_{c} in the case of “presence of shifting”, and otherwise, connection is made to Wi-Fi. Further, the threshold THₐ against the congestion ratio in the priority table is compared with E/W calculated in the step FL509 in the case of “lack of shifting”, and the threshold TH_{c} against the throughput of Wi-Fi in the priority table is compared with W acquired in the step FL506 (step FL515). If E/W is smaller than the threshold THₐ, and W is greater than the threshold TH_{c}, connection is made to Wi-Fi, and connection is made to EV-DO otherwise. The congestion-ratio threshold in the case of “presence of shifting” is defined as E/W>TH_{c} to thereby set such that connection to EV-DO wide in area takes priority, whereas the congestion-ratio threshold in the case of “lack of shifting” is defined as E/W<TH_{c} to thereby set such that connection to Wi-Fi high in throughput takes priority.

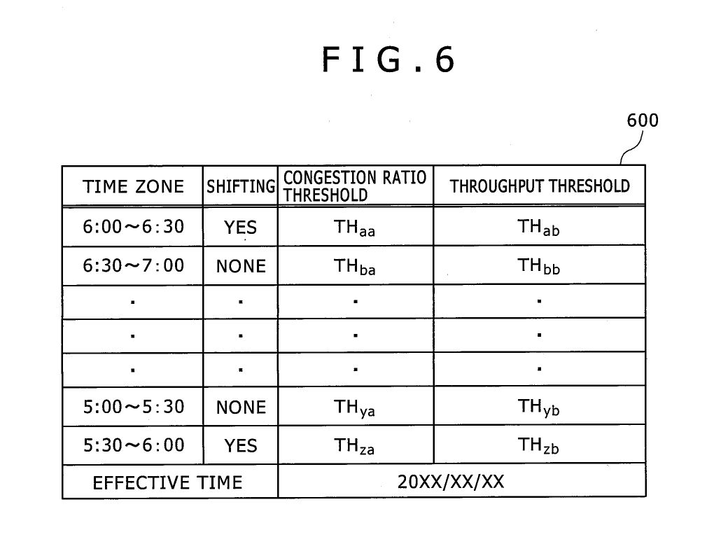

Next, a format of a priority table is described hereinafter by way of example with reference to FIG. 6. Data for one day, from 6:00 to 6:00 on the following day, is stored in the priority table, the data being divided into respective data-blocks for a time length in increments of 30-minutes. The mobile information, the congestion ratio threshold, and the throughput threshold are shown so as to correspond to respective divided data-blocks. The throughput threshold in the case of “presence of shifting” is a threshold for EV-DO, and the throughput threshold in the case of “lack of shifting” is a threshold for Wi-Fi. Furthermore, information on the effective time of the priority table is also stored aside from these data-bocks.

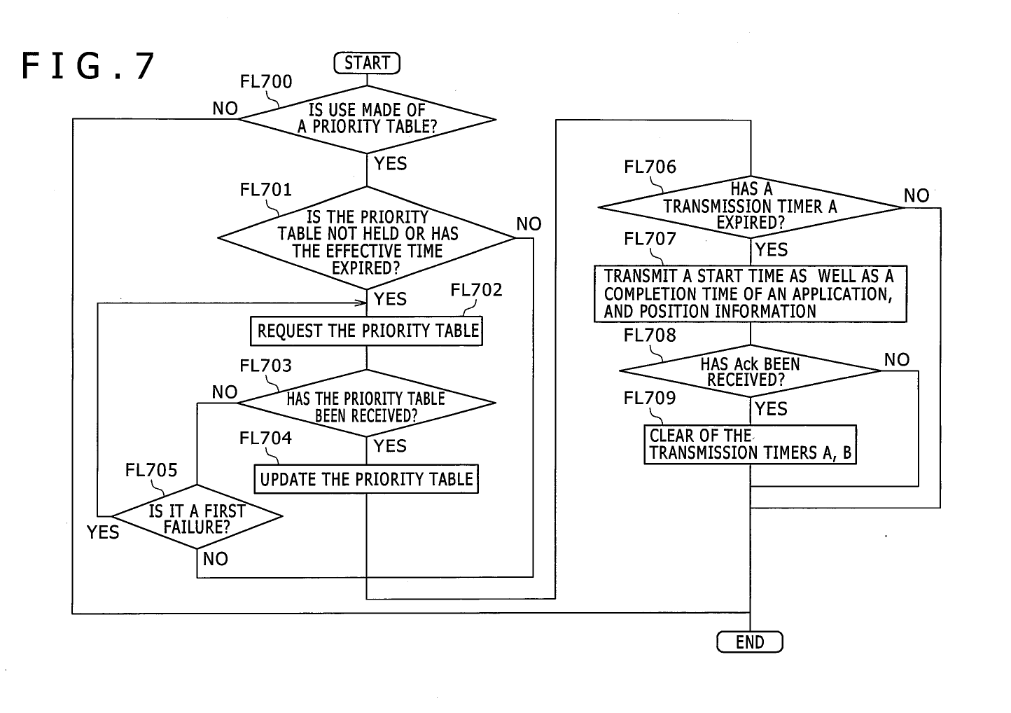

Next, referring to FIG. 7, there are described hereinafter a series of flows whereby the wireless terminal executes a request as well as receipt of the priority table to be accompanied by updating of the priority table, and an activation start time as well as a completion time of an application, and a position information are transmitted. A priority table updating-request, a receipt thereof, and updating of the priority table are described in steps from FL700 through FL705. This processing is started when the wireless terminal starts a call-connection, or with the elapse of given time after a call-connection is executed on an on-again and an off-again basis. First, the wireless terminal determines whether or not the priority table is used, completing the processing if the priority table is not used (step FL700). In the case where the priority table is used, the wireless terminal determines whether or not the priority table is held, and if the effective time has not expired even when the priority table is held (step FL701). If the priority table is held and the effective time has not expired, the processing proceeds to a determination in a step FL706. If the priority table is not held, or the effective time has expired even though the priority table is held, the wireless terminal makes a request for a priority table to the priority table control server (step FL702). Then, the wireless terminal determines whether or not the priority table is received from the priority table control server (step FL703), and if the priority table is not received, the wireless terminal makes a request for the priority table again in the case of a first failure, however, in the case of a second failure, the processing proceeds to the step FL706 (step FL705). If the priority table is received in the step FL703, the priority table is updated (step FL704), and the processing proceeds to the step FL706.

Next, there is described hereinafter a method for transmitting an activation start time as well as a completion time of an application, and position information items. Two transmission timers A, B (a transmission timer A, a transmission timer B) are used in this example, and the transmission timer A has timer-time for one hour. First, a determination on whether or not the transmission timer A has expired is made (the step FL706), and if the transmission timer A has not expired, the processing is completed. If the transmission timer A has expired, the activation start time as well as the completion time of the application, and the position information, which are held in the wireless terminal, are transmitted to the priority table control server. Herein, if the application is continuously used, and the transmission timer A has expired, a time when reporting is made is set to the completion time of the application, and the position information items are transmitted to the priority table control server (step FL707). These information is transmitted, and a determination on whether or not Ack has been received from the priority table control server is made (step FL708), and if Ack has not been received, the processing is completed, whereas if Ack has been received, the transmission timer A, the transmission timer B, the activation start time as well as the completion time of the application, and the position information, which are held in the wireless terminal, are all cleared to thereby complete the processing. If the application is continuously used and the transmission timer A has expired, a time when reporting is made is held as a new completion time of the application (step FL709).

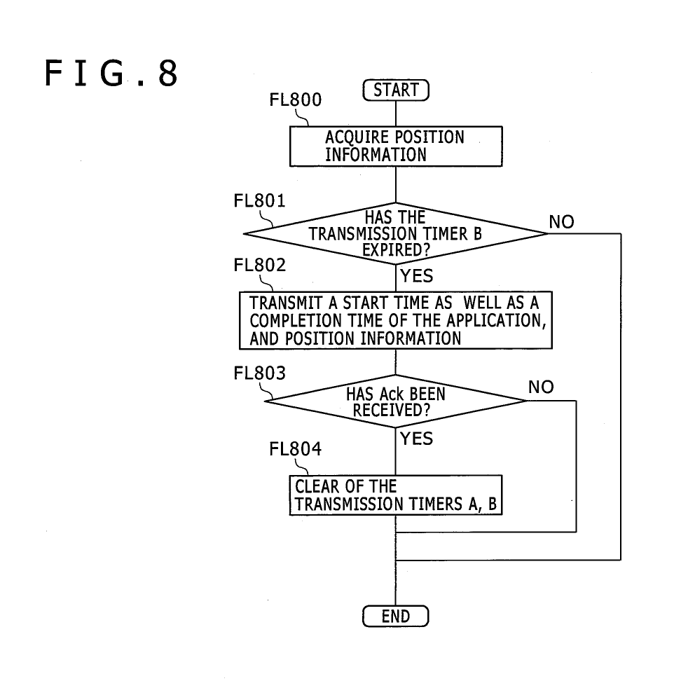

The transmission timer B is described with reference to FIG. 8. For example, this flow starts in increments of 5 minutes. First, GPS or a gyro-sensor and an acceleration sensor are used to calculate and acquire a position information item (step FL800). In this case, the transmission timer B has timer-time for three hours, and a determination on whether or not the transmission timer B has expired is made (step FL801). If not, the processing is completed. If the transmission timer B has expired, a call-connection is executed, and the activation-start time as well as the completion time of the application, and the position information items, which are held in the wireless terminal, are transmitted to the priority table control server. An operation at a time when the application is continuously used, while the transmission timer B has expired, is identical to that in the step FL707 (step FL802). These information items are transmitted, and a determination on whether or not Ack has been received from the priority table control server is made (step FL803), and if Ack has not been received, the processing is completed, whereas if Ack has been received, the transmission timer A, the transmission timer B, the activation-start time as well as the completion time of the application, and the position information, which are held in the wireless terminal, are all cleared to thereby complete the processing (step FL804). Further, a plurality of the transmission timers, that is, the transmission timers A, B, are provided in FIGS. 7, 8, respectively, however, the transmission timer B only may be provided. Further, the transmission timers A, B have the timer-time for one hour, and the timer-time for three hours, respectively, however, the timer-time may be optionally set. Further, a configuration is preferably adopted whereby the transmission timer A<the transmission timer B is set, and transmission is executed in a cycle of transmission to the priority table control server by use of the transmission timer A to enable the priority table control server to be provided with the activation-start time as well as the completion time of the application, and the position information without execution of a wasteful call-connection, information-transmission to the priority table control server being executed by the transmission timer B only when the information-transmission could not be executed. Thus, transmission of the information items accumulated in the wireless terminal can be implemented without execution of the wasteful call-connection as much as possible.

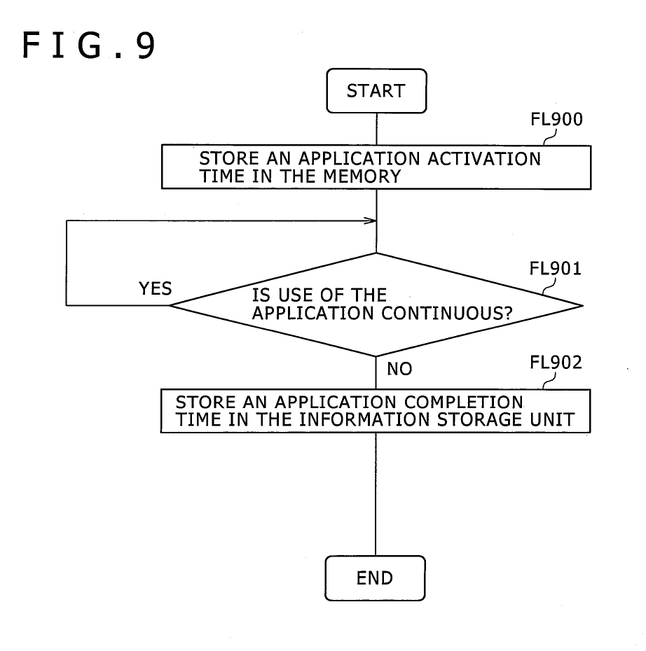

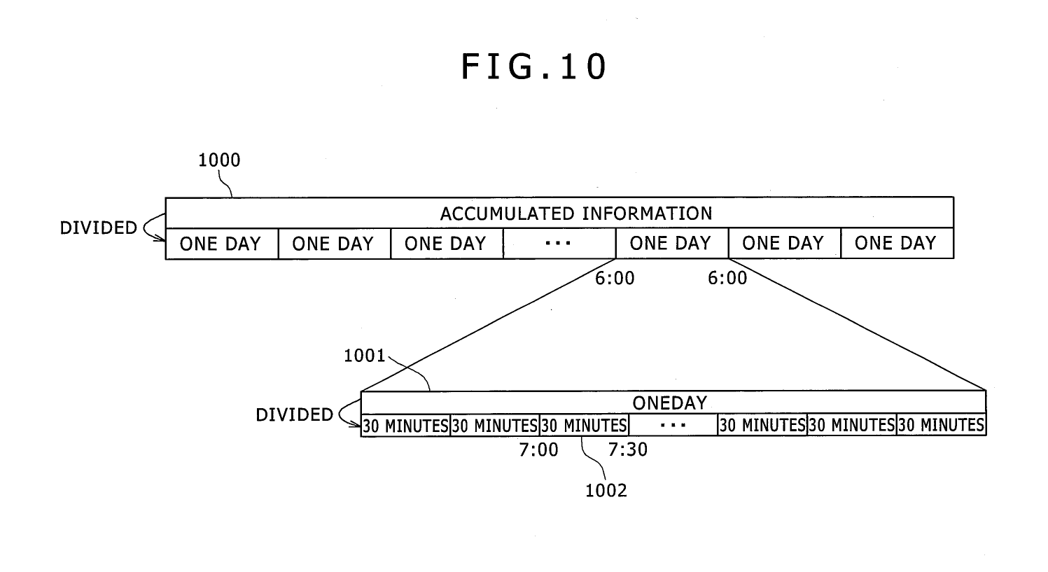

Next, a method for acquiring an application activation-time is described with reference to FIG. 9. A series of flows start when an application is activated by the wireless-terminal, and at first, an application-activation time is stored in the information-storage unit (step FL900). Thereafter, monitoring on whether or not use of the application is continuous is made (step FL901), and if use of the application is completed, an application completion time is stored in the information-storage unit to thereby complete the processing (step FL902). Now, referring to FIG. 10, there are described hereinafter past application activation-times as well as past position information items, accumulated in the priority table control server, and divided information items thereof. The past application start times as well as the past completion times, and the past position information items, for a plural-days portion, as transmitted from the wireless-terminal, are stored in accumulated information 1000. The information is divided into information items for a number of days by defining a time period from 6:00 to 6:00 on the next day as a one-day portion. A divided information item 1001 for the one-day portion, obtained by dividing the accumulated information 1000, is further divided in increments of 30 minutes, which is executed for a plural-days portion. By so doing, the information is divided into information items, each thereof being partitioned into time zones in increments of 30 minutes, such as for example, a time zone from 7:00 to 7:30, as in the case of a divided information 1002 divided in increments of 30 minutes, as an example of a divided information. For example, in the case where the application start time of an application A is 6:45, and the completion time thereof is 7:42, the divided information 1002 is divided such that 6:45 is the start time, and 7:00 is the completion time between 6:30 and 7:00, and 7:00 is the start time, and 7:42 is the completion time between 7:30 and 8:00. These division timing may be periodically divided even when the information is transmitted from the wireless terminal every other one hour or every other three hours.

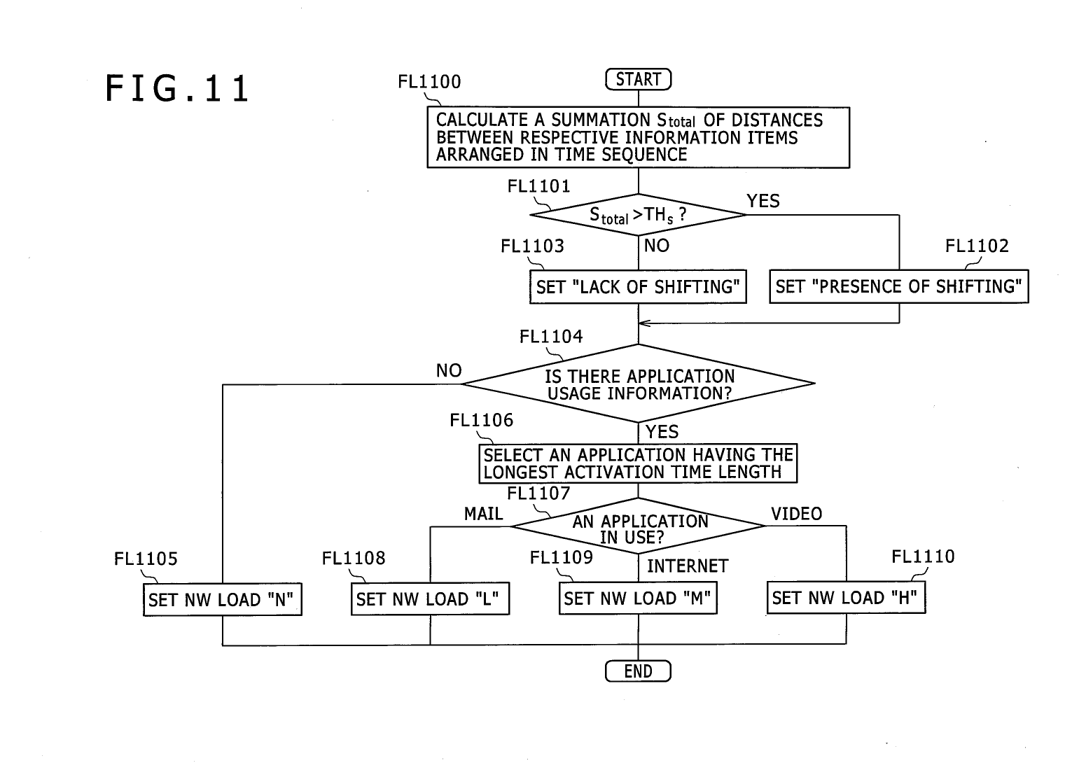

A method for deciding shift information for every other 30 minutes such as the divided information 1002 divided in increments of 30 minutes shown in FIG. 10, and a method for deciding a network load of an application are described hereinafter with reference to FIG. 11. This logic starts when the information items divided in increments of 30 minutes are obtained. Six information items, each being obtained in increments of five minutes, are stored in time sequence in 30 minutes, and a distance between the respective information items is found to thereby calculate a summation Sₜₒₜₐₗ by adding up all the distances together (step FL1100). A threshold THₛ corresponding to Sₜₒₜₐₗ is compared with Sₜₒₜₐₗ to thereby determine whether this is the case of “presence of shifting” or the case of “lack of shifting. {the threshold THₛ is pre-decided by the operator (step FL1101)} If Sₜₒₜₐₗ is greater than the threshold THₛ, a determination on “presence of shifting” (step FL1102) is made, otherwise making a determination on “lack of shifting” (step FL1103). A determination is made on whether or not an activation-start time as well as an activation completion time of the application is present for the 30 minutes after these determinations (step FL1104), and if neither the activation start time nor the activation completion time of the application is present, the network load is determined as “N”. The network load “N” means that no network load exists (step FL1105). If the activation start time as well as the activation completion time of the application exists, and a time length obtained by subtracting the activation start time from the activation completion time of an application is an activation time length of the application. Then, if the same application has an activation start time as well as an activation completion time a plurality of times, respective activation time lengths are calculated to be added together to thereby select an application having the longest activation time length in the 30-minute interval from the result of the calculation (step FL1106). Then, a network load is determined according to the application selected. In this example, mention is made only of video, Internet, and mail (step FL1107). If the application is for video, the network load is determined as “H”, if the application is for Internet, the network load is determined as “M”, and if the application is for mail, the network load is determined as “L”. The network loads “H”, “M”, and “L” mean that the network loads are at a high degree, an intermediate degree, and a low degree, respectively (steps FL1108 through FL1110). Steps FL1100 through FL1110 in the flowchart are performed for one 30-minute division in one day.

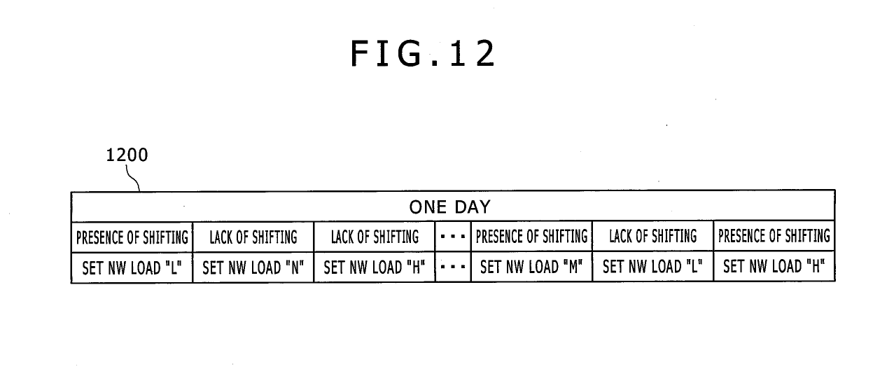

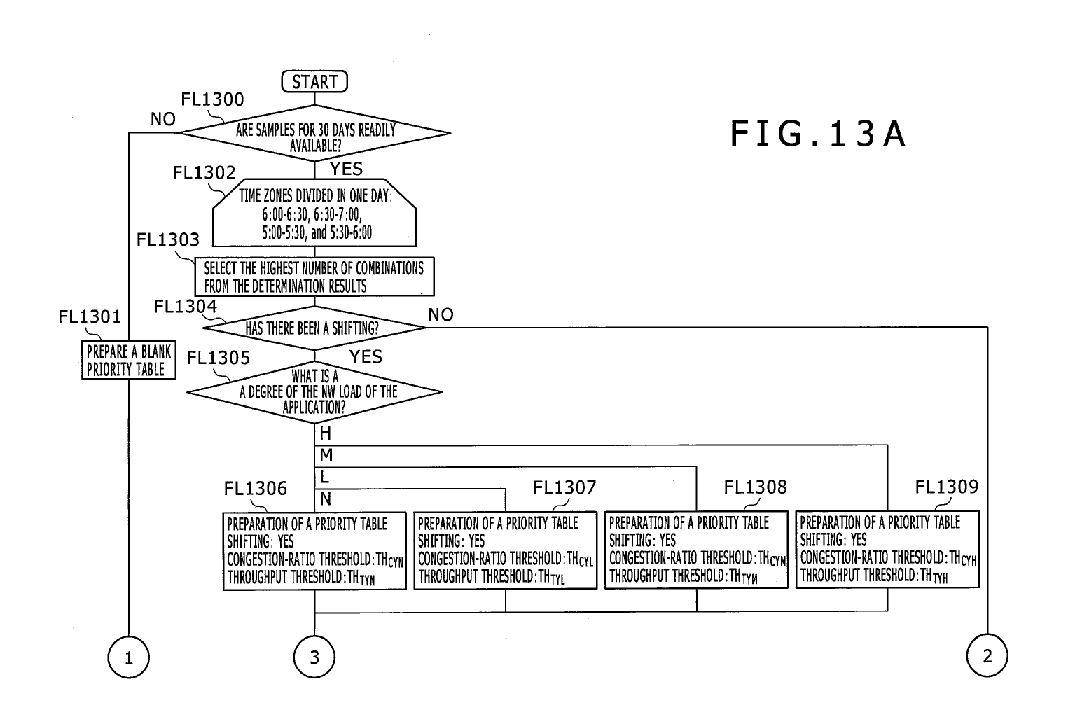

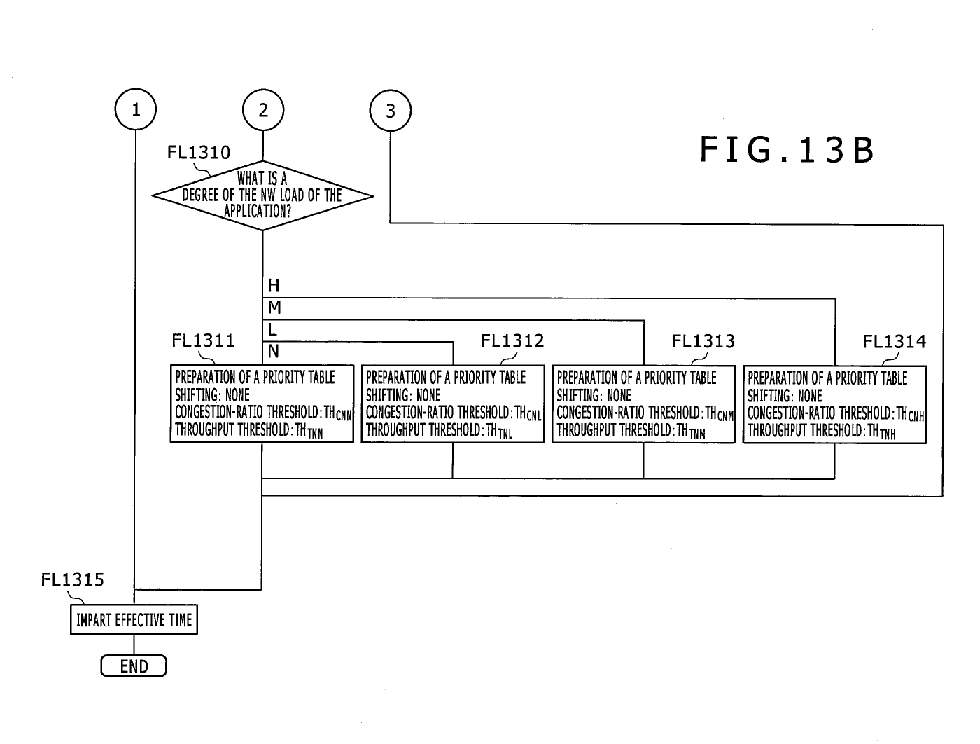

The results of determinations obtainable in FIG. 11 are described with reference to FIG. 12. A determination result 1200 for one day is obtained by execution of an operation of a flow chart shown in FIG. 11 whenever necessary once in every 30-minute intervals. Further, a sample for a plural-days portion is prepared by continuing the operation. A method for preparing the priority table by use of the determination result 1200 is described with reference to FIGS. 13A, and 13B. This logic starts in a predetermined cycle of not less than one day. First, there is made a determination on whether or not samples for a number of days, required for preparation of the priority table, are readily available. In this case, the samples necessary for the number of days, required for preparation of the priority table, are for 30 days (step FL1300). If the samples for 30 days are not readily available, a blank priority table is prepared (step FL1301). Any among the mobile information, the congestion-ratio threshold, and the throughput threshold is not stored in this priority table. Further, this applies to all the time zones in one day. If the samples for 30 days are readily available in the step FL1300, processing proceeds to the next step. The mobile information, the congestion-ratio threshold, and the throughput threshold, for every other 30 minutes, are prepared from the samples for 30 days in steps FL1302 through FL1314. A combination between the mobile information and the network load degree, at the highest number, is selected from among the determination results for 30 days, other than the load N, at an identical time. More specifically, if a sample for a 10-day portion includes shifting: presence, and the load L, a sample for a 12-days portion includes shifting: lack, and the load H, and a sample for a 8-days portion includes shifting: presence, and the load M, the combination for the 12-days portion is at the highest number, and therefore, this is selected. If two types or more of combinations, at the highest number, exist among the determination results, other than the load N, one having the highest load is selected. If a combination does not exist among the determination results, other than the load N, a combination at a higher number is selected from a combination of (shifting: presence), and the load N, and a combination of (shifting: lack), and the load N (FL1303). A determination is made on whether or not the mobile information of the combination as selected is (shifting: presence) (FL1304). If the mobile information is (shifting: presence), a degree of the network load is determined (FL1305). Then, a congestion-ratio threshold, and a throughput threshold are set according to the degree of the network load, whereupon the congestion-ratio threshold, the throughput threshold, and the mobile information are stored in the priority table to thereby prepare the priority table. It is necessary for the operator to pre-decide the congestion-ratio threshold, and the throughput threshold, corresponding to the respective degrees of the network loads (steps 1306 through 1309). If EV-DO wide in cover area, but low in throughput is selected in the case of “presence of shifting”, this will enable a possibility of changing over the wireless communication method to be reduced, however, when EV-DO is congested, the congestion-ratio threshold corresponding to the degree of the network load, and the throughput threshold of EV-DO are set to large values in order to increase the tendency of offloading from EV-DO to Wi-Fi instead of forcefully executing connection to EV-DO to the extent of raising the network load. More specifically, a relationship of TH_{CYN}<TH_{CYL}<TH_{CYM}<TH_{CYH} is imparted to the respective congestion-ratio thresholds, and a relationship of TH_{TYN}<TH_{TYL}<TH_{TYM}<TH_{TYH} is imparted to respective throughput thresholds of EV-DO. If a determination is made on the basis of only the mobile information by increasing the tendency of offloading, and EV-DO is selected as in the case of the presence of shifting, it is possible to realize offloading according to the network load of an application even when EV-DO circuits are congested.

Further, in the case where the mobile information of the combination indicates the lack of shifting in the step FL1304, a determination on the degree of the network load is made (step FL1310), a congestion-ratio threshold and a throughput threshold are set according to the degree of the network load, and the mobile information, the congestion-ratio threshold, and the throughput threshold are stored in the priority table to thereby prepare the priority table (steps FL1311 through 1314). In the case of the lack of shifting, it is possible to make effective use of the wireless resources of EV-DO by selecting Wi-Fi narrow in the cover area, but high in the throughput; however, when Wi-Fi is congested, the congestion-ratio threshold corresponding to the degree of the network load is set to a large value, and the throughput threshold of Wi-Fi is set to a small value in order to increase the tendency of offloading from Wi-Fi to EV-DO instead of forcefully executing connection to Wi-Fi to the extent of raising the network load. More specifically, a relationship of TH_{CNN}<TH_{CNL}<TH_{CNM}<TH_{CNH} is imparted to the respective congestion-ratio thresholds, and a relationship of TH_{TNN}<TH_{TNL}<TH_{TNM}<TH_{TNH} is imparted to the respective throughput thresholds of Wi-Fi. If a determination is made on the basis of only the mobile information by increasing the tendency of offloading, and Wi-Fi is selected as in the case of the lack of shifting, it is possible to realize offloading according to the network load of an application even when Wi-Fi circuits are congested. Further, effective time is imparted to the table, and the effective time in the case of the blank priority table is a time length until the number of days for the samples becomes ready, and otherwise, the operator may decide the effective time (step FL1315). Thus, the priority table described with reference to FIG. 6 is prepared.

As described in the foregoing, the priority table for every relevant time is prepared on the basis of the combination at the highest number from among the past position information items, and the past application activation-times by the priority table control server, thereby providing a connection destination commensurate with an operation high in its ratio to operations conducted by a user. By taking shifting of a user into consideration, frequency of executing a wasteful change-over to a wireless communication method is reduced, and by taking the network load of an application into consideration, use is made of various types of thresholds, so that the wireless resources can be effectively utilized according to a congestion state existing at a time when connection is actually made.

What is claimed is:

1. A wireless communication system comprising:
a wireless terminal compatible with a plurality of wireless communication methods;
a plurality of base stations that communicate with the wireless terminal according to the plural wireless communication methods, respectively; and
a control server that communicates with the plural base stations via a network, and storing priority information including a mobile history information item on the wireless terminal,
wherein the control server for the priority information transmits the priority information to the wireless terminal, and the wireless terminal selects the wireless communication method for use in communications on the basis of the priority information received.

2. The wireless communication system according to claim 1, wherein the plural base stations include a first base station compatible with a first wireless communication method, and a second base station compatible with a second wireless communication method, the second base station being narrower in communication range than the first base station, and a first throughput information received from the first base station is compared with a second throughput information received from the second base station to thereby select a wireless communication method to be used for communications.

3. The wireless communication system according to claim 2, wherein the wireless terminal selects the wireless communication method for use in communications on the basis of an application usage history information item included in the priority information.

4. The wireless communication system according to claim 3, wherein the application usage history information includes a network load information item of an application.

5. The wireless communication system according to claim 1, wherein the control server works out a mobile distance of the wireless terminal in predetermined time according to a mobile history information item previously stored, and if the mobile distance worked out is greater than a predetermined threshold, a determination as presence of shifting is made and the wireless communication method for use in communications is selected on the bass of the result of the determination.

6. The wireless communication system according to claim 5, wherein if the control server makes the determination as the presence of shifting, and a value obtained by dividing a first throughput information by a second throughput information is greater than a first threshold prestored and a first throughput is greater than a second threshold prestored, the first wireless communication method is selected.

7. The wireless communication system according to claim 5, wherein if the control server makes a determination as lack of shifting, and a value obtained by dividing the first throughput information by the second throughput information is smaller than the first threshold prestored and a second throughput is greater than the second threshold prestored, the second wireless communication method is selected.

8. A control server for receiving priority information including a mobile history information item transmitted from a wireless terminal compatible with a plurality of wireless communication methods, the control server comprising:
a storage unit that stores the priority information;
a priority table preparation unit that prepares a priority table on the basis of the priority information stored; and
a communications unit that transmits the priority table prepared to the wireless terminal in response to a request from the wireless terminal.

9. The control server according to claim 8, wherein a mobile distance of the wireless terminal in predetermined time is worked out according to the mobile history information as received, and if the mobile distance as worked out is greater than a predetermined threshold, a determination as presence of shifting is made, the result of the determination being reflected in the priority table.

10. The control server according to claim 9, wherein the priority information includes an application usage history information, and indicates a wireless communication method to be used in communications to the wireless terminal on the basis of the mobile history information and the application usage history information.

11. A wireless terminal compatible with a plurality of wireless communication methods, the wireless terminal comprising:
a memory that stores mobile history information on the wireless terminal;
a communication unit that transmits the mobile history information stored on one hand, and receiving a priority table prepared by a control server on the basis of the mobile history information transmitted; and
a controller that selects one of the plural wireless communication methods on the basis of the priority table received.

12. The wireless terminal according to claim 11, wherein a wireless communication method is selected on the basis of an application usage history information item included in the priority table.

13. The wireless terminal according to claim 12, wherein the application usage history information includes a network load information item of an application.
